(19) United States
(12) Patent Application Publication
(10) Pub. No.: US 2014/0048427 A1
(43) Pub. Date: Feb. 20, 2014

(54) INSERT FOR COMMEMORATIVE AIR-CAPTURING KEEPSAKE

(71) Applicant: Edward HELBLING, Northport, NY (US)

(72) Inventor: Edward HELBLING, Northport, NY (US)

(21) Appl. No.: 14/066,245

(22) Filed: Oct. 29, 2013

Related U.S. Application Data
(63) Continuation-in-part of application No. 13/024,869, filed on Feb. 10, 2011.

(51) Int. Cl. F17C 13/00; F16K 21/16

(52) U.S. Cl. CPC F17C 13/005; F16K 21/16
USPC 206/6; 251/22

(57) ABSTRACT

A closed container having an interior at subatmospheric pressure is provided with an insert having top and bottom telescoped sleeves defining a closed chamber. The bottom sleeve has a bottom wall formed with a hole exposed at or through the container to ambient air at ambient pressure. The top sleeve is movable relative to the bottom sleeve between a raised position standing up from the bottom sleeve and a lowered position nested with the bottom sleeve. Latch elements connected between the sleeves are operable from outside the container between a latching position engaged together and preventing the top sleeve from moving into the raised position and a disengaged position permitting such movement. Thus, when the latch elements are moved out of the engaged position, the top sleeve moves into the raised position and air is aspirated through the hole into the chamber.

### CROSS REFERENCE TO RELATED APPLICATION

This application is related to copending application Ser. No. 13/024,869 filed 10 Feb. 2011.

### FIELD OF THE INVENTION

The present invention relates to commemorative air-capturing keepsake. More particularly this invention concerns an insert for such a keepsake.

### BACKGROUND OF THE INVENTION

As described in the above-cited copending application, a commemorative keepsake comprises a closed container bearing indicia or a placard identifying an event or place, such as the Superbowl, someone's wedding or christening, or the Grand Canyon. The interior of the container is under subatmospheric pressure and a valve is provided capable of being opened so that ambient air around the container can be aspirated by the pressure differential into the container and trapped therein, normally in that the valve only works to admit air.

In some models of this keepsake the container is at least partially transparent and holds a model of something related to the event. Thus the interior can hold a small model of tiered wedding cake or other structure.

The criticism can be made of this system that the user is not given any assurance or proof that it is actually doing what it is supposed to do, namely suck in ambient air at the event so that the actual air at the event can be preserved as part of the keepsake, imparting some true uniqueness to it.

### OBJECTS OF THE INVENTION

It is therefore an object of the present invention to provide an improved cake insert for commemorative air capture keepsake.

Another object is the provision of such an improved insert for commemorative air capture keepsake that overcomes the above-given disadvantages, in particular that does something to assure the user that air is actually being aspirated into the keepsake at the user's command.

A further object is to increase the visual interest of the keepsake.

### SUMMARY OF THE INVENTION

A closed container having an interior provided with an insert having top and bottom telescoped sleeves defining a closed chamber. The bottom sleeve has according to the invention a bottom wall formed with a hole exposed at or through the container to ambient air at ambient pressure. The top sleeve is movable relative to the bottom sleeve between a raised position standing up from the bottom sleeve and a lowered position nested with the bottom sleeve. Biasing means urges the top sleeve into the raised position. Latch elements connected between the sleeves are operable from outside the container between a latching position engaged together and preventing the top sleeve from moving into the raised position and a disengaged position permitting such movement. Thus, when the latch elements are moved out of the engaged position, the top sleeve moves into the raised position and air is aspirated through the hole into the chamber.

The biasing means may be a simple spring pushing the top sleeve upward and/or a pressure differential between an interior of the container and the chamber.

According to the invention a check valve at the hole only allows air to pass through the hole into the chamber. In addition the bottom sleeve has an upper end provided with an inwardly projecting rim, and the top sleeve has a lower end provided with an outwardly projecting rim engaging under the inwardly projecting rim and preventing movement of the top sleeve beyond the raised position.

A cake-suitable decoration, for instance a candle on the top of at least the top sleeve, gives the two sleeves the appearance of a small cake.

A middle sleeve is telescoped between the top sleeve and the bottom sleeve. It has inner and outer rims like to top and bottom sleeves, and seals engaging surfaces of the top and bottom sleeves.

The latch element on the bottom sleeve has a laterally projecting arm that in the engaged position catches on the latch element of the top sleeve. Thus a simple turn of the bottom latch element frees the top sleeve to rise because of the pressure differential between the chamber inside the insert and the interior of the container around the insert, erecting the “cake” and also aspirating air from outside into it. Of course instead of a cake the insert could be made to have a final shape like that of some other suitable structure such as a building, a stadium, or a sports accessory.

### BRIEF DESCRIPTION OF THE DRAWING

The above and other objects, features, and advantages will become more readily apparent from the following description, reference being made to the accompanying drawing in which:

FIG. 1 is a perspective sectional view of the insert according to the invention in a raised or maximum-volume position;

FIG. 2 is a similar view of the insert of FIG. 1 in a compressed position; and

FIG. 3 is a view like FIG. 2 but not in section of an other embodiment of the invention.

### SPECIFIC DESCRIPTION OF THE INVENTION

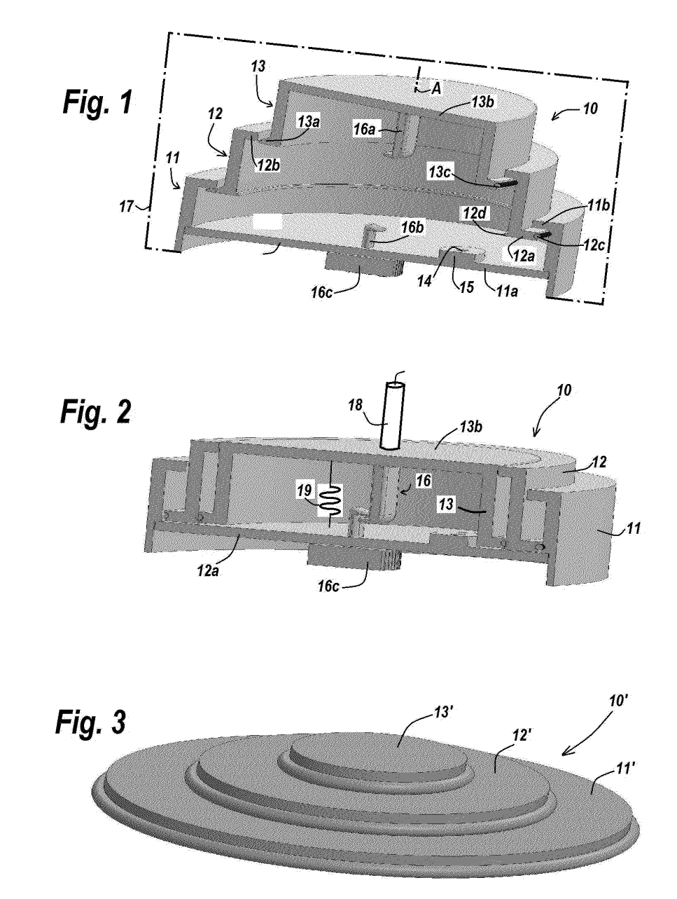

As seen in FIGS. 1 and 2 an insert 10 according to the invention, which is adapted to be fixed to the bottom wall of an unillustrated, closed and evacuated container, comprises three cylindrically tubular bottom, middle, and top sleeves 11, 12, and 13 of decreasing diameter and testable in one another. They are concentric to an axis A.

The bottom and largest-diameter sleeve 11 has a closed bottom wall or floor 11a provided at an inlet hole 14 with a valve 15. This wall 11a is fixed to or forms part of the container illustrated schematically at 17 so that the hole 14 is open at or exposed to the outside air. The valve 15 is a one-way or check valve only permitting gas flow into the insert 10. The bottom sleeve 11 has at its upper end a radially inwardly extending circularly annular rim 11b.

The middle sleeve 12 is of an outside diameter equal to slightly less than the inside diameter of the rim 11b and is provided with a circularly annular rim 12a that projects radially outward under the rim 11b and whose outside diameter is greater than the inside diameter of the rim 11b. An outer edge of this rim 12a carries an O-ring 12c riding on an inner cylindrical surface of the bottom sleeve 11. A radially inwardly projecting circularly annular rim 12b is provided at an upper end of the middle sleeve 12.

The top sleeve 13, which is of an outside diameter equal to slightly less than the inside diameter of the rim 12b, is provided, like the middle sleeve 12, at its lower edge with a rim 13a projecting radially outward underneath the rim 12b and of an outside diameter greater than the inside diameter of this rim 12b. An outer edge of the rim 13a carries an O-ring 13c riding on an in inner cylindrical surface of the middle sleeve 12. A flat and imperforate top wall 13b closes the top of the sleeve 13. The very lower edge of the middle sleeve 12 has a radially inwardly projecting ridge 12d so that the sleeve 12 cannot rise above the sleeve 13. A spring 19 shown only in FIG. 2 may urge the top sleeve 13 upward.

The sides and tops of the sleeves 11, 12, and 13 are normally decorated like the sides of a cake and the top of the sleeve 13 is provided with miniature decorations (see 18 only in FIG. 2), for instance birthday candles or a wedding-cake bride-and-groom miniature.

A simple latch 16 is formed by an L-shaped element 16a projecting axially downward from and fixed to the center of the top wall 13b and another L-shaped element 16b projecting up through the bottom wall 11a and provided underneath the wall 11a in a position accessible from outside the container 17 with a crosspiece handle 16c. In the compressed condition, a laterally projecting upper arm of the lower element 16b overlies a laterally projecting lower arm of the upper element 16a, locking the top sleeve 13 down on the bottom sleeve 11 as shown in FIG. 2.

The insert is in the FIG. 2 compressed position when the keepsake is received by the end user, that is with the “cake” formed by the sleeves 11-13 collapsed and visible inside the partially transparent keepsake container 17. Also, when the keepsake is received by the end user, the interior of the container 17 around the insert 10 is evacuated or at the very least at a significantly below atmospheric pressure. On the other hand the interior of the insert 10, because of the hole 14 and check valve 15, is at ambient pressure. Thus the pressure inside the insert 10 is greater than that outside and the top sleeve 13 is urged upward by the pressure beneath it.

To activate the keepsake and aspirate ambient air from the event or place into it, the user turns the handle 16c. This action separates the arms of the elements 16a and 16b, so that the top sleeve 13 is freed and will naturally rise and pull up the middle sleeve 13 and erect the “cake” in the sleeves 11-13. This will be visible to the user of the keepsake and will be not only amusing, but proof that the device is actually filling with the desired keepsake air.

FIG. 3 shows another insert 10′ that works the same as that of FIGS. 1 and 2, but that is of substantially lower profile, with flatter bottom, middle, and top sleeves 11′, 12′, and 13′.

I claim:

1. In combination with a closed container, an insert comprising:
a bottom sleeve fixed in the container and having a bottom wall formed with a hole exposed at or through the container to ambient air at ambient pressure outside the container;
a top sleeve telescoped with the bottom sleeve, forming therewith a chamber closed except at the hole, and movable relative to the bottom sleeve between a raised position standing up from the bottom sleeve and a lowered position nested with the bottom sleeve;
means urging the top sleeve into the raised position;
top and bottom latch elements connected between the sleeves and operable from outside the container between a latching position engaged together and preventing the top sleeve from moving into the raised position and a disengaged position permitting such movement, whereby, when the latch elements are moved out of the engaged position, the top sleeve moves into the raised position and air is aspirated through the hole into the chamber.

2. The insert defined in claim 1, further comprising:
a check valve at the hole only allowing air to pass through the hole into the chamber.

3. The insert defined in claim 1, wherein the bottom sleeve has an upper end provided with an inwardly projecting rim and the top sleeve having a lower end provided with an outwardly projecting rim engaging under the inwardly projecting rim and preventing movement of the top sleeve beyond the raised position.

4. The insert defined in claim 1, further comprising:
a cake-suitable decoration on at least the top sleeve.

5. The insert defined in claim 2, further comprising:
a middle sleeve telescoped between the top sleeve and the bottom sleeve.

6. The insert defined in claim 1, wherein the latch element on the bottom sleeve has a laterally projecting arm that in the engaged position catches on the latch element of the top sleeve.

7. The insert defined in claim 1, wherein container defines around the insert a closed interior that is under subatmospheric pressure, whereby the means is the pressure differential between the interior of the container and the chamber.

8. The insert defined in claim 1, wherein the means is a spring.

9. In combination with a closed container having an interior at subatmospheric pressure, an insert comprising:
a bottom sleeve fixed in the container and having a bottom wall formed with a hole exposed at or through the container to ambient air at ambient pressure outside the container;
a top sleeve telescoped with the bottom sleeve, forming therewith a chamber closed except at the hole, and movable relative to the bottom sleeve between a raised position standing up from the bottom sleeve and a lowered position nested with the bottom sleeve; and
top and bottom latch elements connected between the sleeves and operable from outside the container between a latching position engaged together and preventing the top sleeve from moving into the raised position and a disengaged position permitting such movement, whereby, when the latch elements are moved out of the engaged position, the top sleeve moves into the raised position and air is aspirated through the hole into the chamber.
